(19) United States
(12) Patent Application Publication
(10) Pub. No.: US 2017/0098882 A1
(43) Pub. Date: Apr. 6, 2017

(54) DESIGN OF DUAL LOADED RFID TAG FOR HIGHER ORDER MODULATIONS

(71) Applicants: Shadi Ebrahimi-Asl, Morrisville, NC (US); Mohammad Tayeb Ahmad Ghasr, Rolla, MO (US); Maciej Jan Zawodniok, Rolla, MO (US)

(72) Inventors: Shadi Ebrahimi-Asl, Morrisville, NC (US); Mohammad Tayeb Ahmad Ghasr, Rolla, MO (US); Maciej Jan Zawodniok, Rolla, MO (US)

(21) Appl. No.: 15/281,882

(22) Filed: Sep. 30, 2016

Related U.S. Application Data
(60) Provisional application No. 62/236,490, filed on Oct. 2, 2015.

(51) Int. Cl. H01Q 1/22; H01Q 5/49; H01Q 1/36

(52) U.S. Cl. CPC H01Q 1/2225; H01Q 1/36; H01Q 5/49

(57) ABSTRACT

Methods, systems, and apparatus for an improved antenna, specifically a T-match bowtie antenna system, including a t-match antenna having a first side and a second side, wherein the antenna is dual loaded; a first load soldered to the first side of the antenna; a second load soldered to the second side of the antenna; and a gap defined by the space between the first load and the second load, wherein the gap is approximately one millimeter; where the antenna is capable of providing quasi-32-QAM encoding.

### CROSS-REFERENCE TO RELATED APPLICATIONS

This application claims the benefit under 35 U.S.C. §119(e) of U.S. Provisional Patent Application No. 62/236,490, entitled “Method and Device for Improving Performance of RFID System,” filed Oct. 2, 2015, which is incorporated herein by reference in its entirety.

### GRANT STATEMENT

This invention was made with government support under NSF CNS-0954031, ECCS-1310425, and IIP-1623905 awarded by the National Science Foundation. The Government has certain rights in the invention.

### BACKGROUND

This specification relates to the field of electronic circuitry. More specifically, the present technology is in the technical field of radio-frequency identifier circuitry.

The touchstone model for selecting two scattering states for scalar differential backscattering in passive scatterers was introduced in 1963 by Green. According to this model, a scatterer has one global minimum and one global maximum scattering states on its Γ plane. The variation of RCS of the scatterer between these two states is monotonic.

Passive radio frequency identification (RFID) systems have been very popular recently in numerous short range data communication applications (e.g., sensor networks, data acquisition, object tracking, retail industry, etc.). The basic operation of a passive RFID system is as follows. An RFID reader sends out an interrogation signal to a target RFID tag and calls out its ID. The reader finishes its interrogation by a tone signal. By impinging the signal on the antenna structure of the target energy is induced at the tag. The tag uses this energy to run its internal circuitry and check if its ID has been interrogated. If the interrogated ID matches with that of the tag it sends backs its stored data by differential backscattering.

To this end, during the finishing tone signal from reader antenna the tag switches its load impedance between two values to change its scattering state. This way, the tag actually changes its radar cross section (RCS) between two values. Thus, it is able to encode either “0” or “1” bits—from its stored data—by two RCS values. This modulation scheme has in fact been accomplished by a change in the amplitude of backscattered signal. Thus, it is regarded as an Amplitude Shift Keying modulation.

Current measurements and simulations, however, cannot be modeling by the Green model, and certain antenna designs have faulty assumptions surrounding them. What is needed is a more accurate and useful measurement, simulation, and design of such components.

The present novel technology addresses these needs.

### SUMMARY

This specification describes technologies relating to RFID circuits.

This specification further verifies by measurements and simulations that a linear half-wave dipole antenna responds as predicted by Green model. However, we show that the variation of RCS of a T-match bowtie antenna over its Γ plane cannot be modeled by Green model and the antenna has two maximum scattering states on its Γ plane. In the next portion, we introduce dual loading on the structure of T-match bowtie antenna. By appropriate selection of the loads of the antenna it can be placed at various scattering states with various magnitudes within 360° phase span in I-Q plane. This feature of the proposed antenna can be used to increase the modulation depth to 170%, provide a quasi-32-QAM, and increase coverage range in passive backscattering links.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of representation of (−Aₛ) for the studied half wave dipole, wherein the RCS for the loads which are close to Γ=−Aₛ are low.

FIG. 2A is a first diagram of the variation of RCS for the studied half wave dipole.

FIG. 2B is a second diagram of the variation of the induced phase of the current (degree) for the studied half wave dipole.

FIG. 3A is a diagram of the variation of RCS of T-match bowtie antenna on different Γᵣ line.

FIG. 3B is a diagram of the variation of the induced phase (Φ) on different r, line.

FIG. 4A is a diagram of the variation of the RCS (Φ) in the left side of the Γ plane.

FIG. 4B is a diagram of the variation of the induced phase in the left side of the Γ plane.

FIG. 5A is a diagram of the selected loads for half-wave dipole (lighter markers) and T-match bowtie antennas (darker markers), where load impedances from each antenna's Γ plane are shown on a common Γ plane. The impedance of the diode in its forward bias (1Ω+0.7 nH) is also added to the total load at the input port of the antennas.

FIG. 5B is a diagram of a prepared T-match bowtie antenna for measurement.

FIG. 5C is a diagram of the measurement setup.

FIG. 6 is a diagram of the measured S₁₁.

FIG. 7A is a diagram of the demodulated signal from half-wave dipole antenna measuring differential backscattering from antennas.

FIG. 7B is a diagram of the demodulated signal from T-match bow tie antenna measuring differential backscattering from antennas.

FIG. 8 is a diagram of the proposed design for dual loading in the studied T-match antenna.

FIG. 9A is a diagram of the scalar and vector differential backscattering at Load 1=2.2 nH.

FIG. 9B is a diagram of the scalar and vector differential backscattering at Load 1=3.3 nH.

FIG. 9C is a diagram of the scalar and vector differential backscattering at Load 1=5.1 nH.

FIG. 9D is a diagram of the scalar and vector differential backscattering at Load 1=10 nH.

FIG. 9E is a diagram of the scalar and vector differential backscattering at Load 1=12 nH.

FIG. 9F is a diagram of the scalar and vector differential backscattering at Load 1=22 nH.

FIG. 9G is a diagram of the scalar and vector differential backscattering at Load 1=O.C.

FIG. 10 is a diagram of two high scattering states with approximately ˜Δφ=160° phase shift with each other.

FIG. 11A is a diagram of the quasi-32-QAM modulation for passive backscattering links showing scattering states with δ>0.01.

FIG. 11B is a diagram of the quasi-32-QAM modulation for passive backscattering links showing scattering states with δ<0.01.

FIG. 11C is a legend associated with FIGS. 10A and 10B.

Like reference numbers and designations in the various drawings indicate like elements.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not.

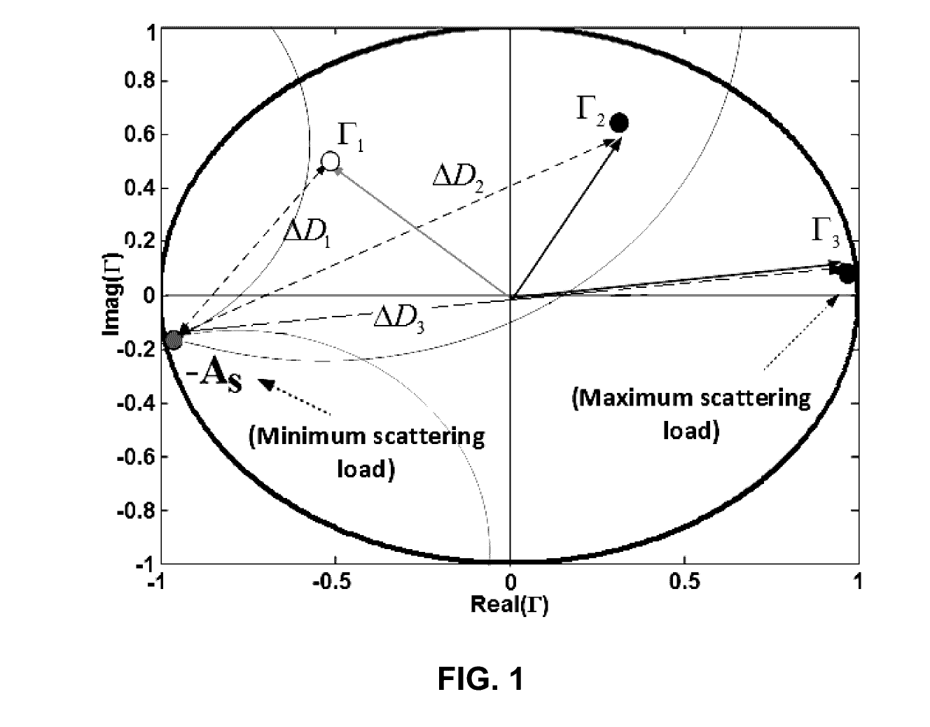

FIGS. 1-11 typically depict various aspects of the present novel technology.

### I. INTRODUCTION

In this description, we call the above-mentioned Amplitude Shift Keying as scalar differential backscattering (SDB). It is also possible to encode the data in backscattering links by Phase Shift Keying modulation. In this method, during the finishing tone signal from reader the tag changes the reactance of its load to produce a change in the phase of its backscattered field. In this paper, we call this modulation type vector differential backscattering (VDB).

Selecting two optimum loads is very critical in achieving the maximum differential signal in both SDB and VDB links. By achieving to higher differential signal in backscattering links the coverage range is increased. Also, backscattering links will be more immune to external noise and interference. A touchstone model to select two best scattering states was introduced by Green. In this model, the RCS from an antenna with impedance Za (Zₐ=Rₐ+jXₐ), loaded with Z_{L} and illuminated by an arbitrary field is shown by

$$σ = \frac{{λ}^{2}}{4 π} {G}^{2} {\vert Γ + {A}_{S} \vert}^{2} \qquad ( 1 )$$

where G is antenna gain at wavelength Λ, Aₛ, is a constant describing structural scattering coefficient of the antenna, and Γ is a modified current reflection coefficient

Γ=(Zₐ*−Z_{L})/(Z_{L}+Zₐ) (2)

such that |Γ|≦1 for all passive loads. The complex modified reflection coefficient (Γ=Γᵣ+j Γᵢ) can be plotted on Γ plane of the antenna by considering z=(ZL+jXa)/Ra and

$$Γ = \frac{1 - z}{1 + z} .$$

In (1), the RCS of the antenna at Γ=−Aₛ is zero and the antenna becomes a minimum scattering antenna. This point can be found on the Γ plane of the antenna by intersecting three scattering circles of the antenna. FIG. 21 shows (−Aₛ) point for a half-wave dipole at f=1 GHz on the Γ plane of the antenna. According to (1), by moving away from (−Aₛ) the right side of (2) increases and so does the RCS of the antenna. Thus, at the farthest point to (−Aₛ), e.g., Γ₃ in FIG. 1, the antenna becomes a maximum scattering antenna. Consequently, the highest differential backscattering signal can be achieved when the load of the antenna is switched between Γ_{load1}=and Γ_{load2}=Γ₃ in this case.

On the other hand, ideally, for VDB links the maximum vector differential backscattering signal is achieved if two maximum scattering states with 180° phase shift are used. This scenario is similar to a pure BPSK modulation with +1/−1 signaling to encode 0 and 1 bits. However, according to (1) an antenna has only one maximum scattering state. Furthermore, achieving 180° phase shift by changing the reactance of the load is very challenging. This issue is discussed more in details in section II and III of this paper. In [7], a quasi-Quadrature Amplitude Shift Keying (QAM) is discussed using four scattering states in 90° phase span in the in-phase and quadrature (I-Q) plane of the demodulated signal from an RFID antenna. Since the proposed scattering states are closely spaced in 90° phase span detection boundaries are defined for decoding the signal. However, by any interference or noise in the environment scattering states are drifted into the detection boundaries of other states resulting in a fault detection. Some other works in the literature have also studied QAM modulations for backscattering links. However, they all use a 50Ω reference impedance to characterize the input impedance of the RFID antenna. Higher order modulations for chip-less RFID tag also has been discussed in the literature. However, chip-less RFID tags have limited applications for identifying limited number of objects and they are not suitable for data communication.

In Section II of this paper, first we study and compare the variation of RCS and the induced phase at the input ports of a linear half-wave dipole antenna and a T-match bowtie antenna over their Γ planes. We show by measurements and simulations that the variation of RCS for the linear half-wave dipole is as described by (1). But, the variation of RCS for the T-match bowtie antenna is not completely defined by (1). In addition to the main maximum scattering area on its Γ plane defined by (1) the T-match bowtie antenna also has a secondary maximum scattering area which is located right next to its minimum scattering area on its Γ planes. As for the variation of the phase over the Γ planes, we show that although for both antennas two scattering states with 180° phase shift can be accomplished the resultant VDB signal is smaller than that of SDB.

Dual loading and multiple loadings have already been used in the literature for reducing measurement errors in material characterizations [12], [13]. In Section III of this paper, we use dual loading to introduce a new RFID tag antenna design which can produce scattering states with various amplitudes within 360° phase span. A 1 mm gap at the center of the studied T-match bowtie antenna is created. This is the first stimulus on the antenna where we use Load 1. The second stimulus of the antenna is set at the original input port of the antenna where we use Load 2. We show by measurements that by load switching at both of the stimuluses of the antenna it is possible to produce various scattering states with different magnitude over 360° phase span on I-Q plane of the demodulated signal. We show that by using the proposed design modulation index is increased up to 170%. Furthermore, a quasi-32-QAM for the backscattering link of the antenna is demonstrated. By using the new RFID antenna design the network coverage in passive backscattering links is increased. Furthermore, higher order modulations can be realized. Conclusions are presented in Section IV.

### II. LINEAR AND RESONANT RFID ANTENNAS

In this Section, we study the variation of RCS and the phase of the induced current for a linear half-wave dipole and the T-match bowtie antenna from [5] over their Γ planes by simulations and measurements. The phase of the induced current is directly proportional to the phase of the scattered electric field from the antennas. It is shown that the behavior of the studied linear half-wave dipole is in agreement with Green model. However, simulations and measurement results show that the studied T-match bowtie antenna has two maximum scattering areas on its I′ plane. This behavior is not predicted by Green model in (1).

A) Linear Half-Wave Dipole

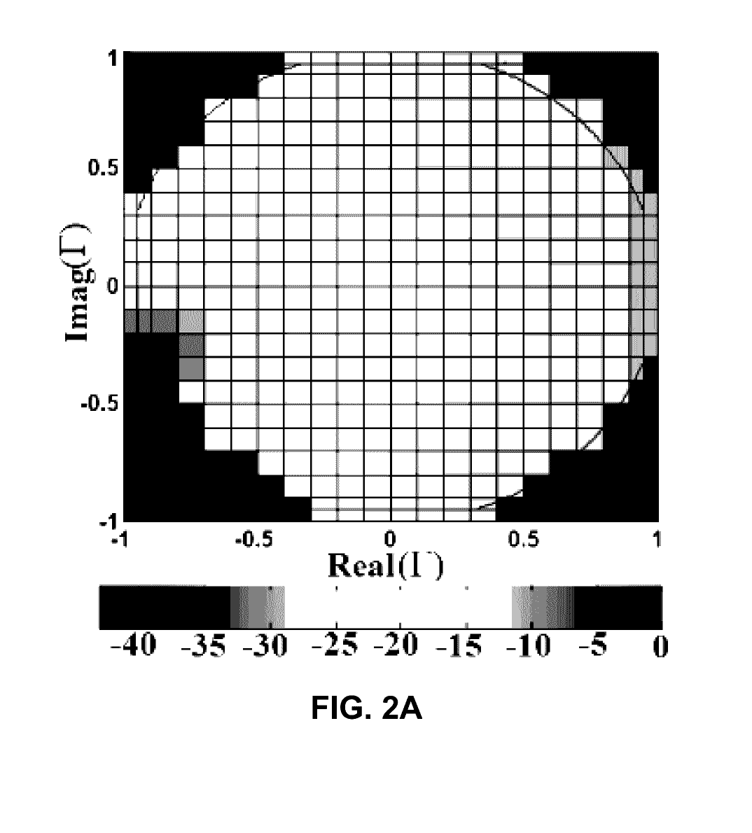

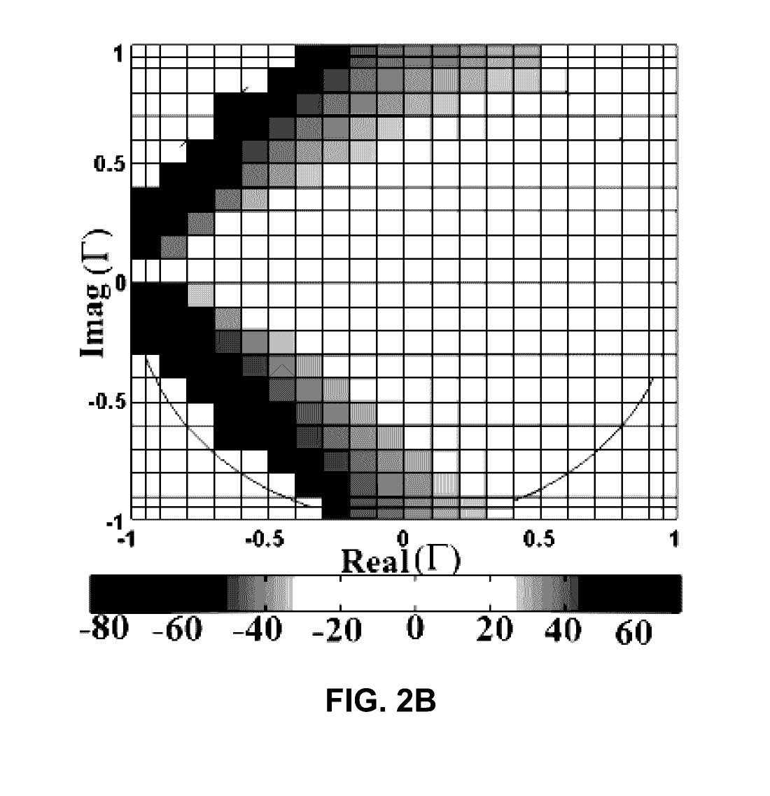

A linear half-wave dipole at f=1 GHz is considered on Rogers RO4350 substrate for simulations and measurements. The substrate and antenna thickness are 0.5 mm and 0.05 mm respectively. The antenna input impedance at the design frequency is Zₐ=114.53+j171.38 using CST Studio simulations. The minimum scattering point for this antenna is <Γᵣ=−0.965, Γᵢ=−0.28> with RCS˜−58 dBsm. The impedance on each point on Γ plane of the antenna is calculated using (2). The step size is considered as ΔΓ=0.1. The RCS and the induced phase over the Γ plane are simulated at each point. FIGS. 2A and 2B show the simulated RCS and the induced phase at the input port of the antenna over its Γ plane. At the selected resolution the minimum scattering point of the antenna is found at <Γᵣ=−0.95, Γᵢ=−0.3> with RCS˜−45 dBsm. By moving away from the minimum scattering point (−Aₛ) the RCS increases until at the right side of the Γ plane it reaches to a maximum around RCS˜−10 dBsm. This behavior of RCS is as described by Green model in (1) and also previously investigated in FIG. 1 in Section I.

The phase of induced current at the input port of the antenna in the bottom side (Γᵢ<0) and top side (Γᵢ>0) of Γ plane is respectively negative and positive as understood form FIG. 2B. Furthermore, the maximum differential phase on the line Γᵣ=0.98, i.e., the maximum scattering area, is almost ΔΦ˜25°. On the other hand, the maximum differential phase on line Γᵣ=−0.98, i.e., the minimum scattering area, reaches to ΔΦ˜16°. Although the differential phase is high in this area the variation of RCS is very negligible. Thus, it is not possible to employ the high differential phase in this region to achieve to a wide differential backscattering signal.

B) Resonant T-Match Bowtie Antenna

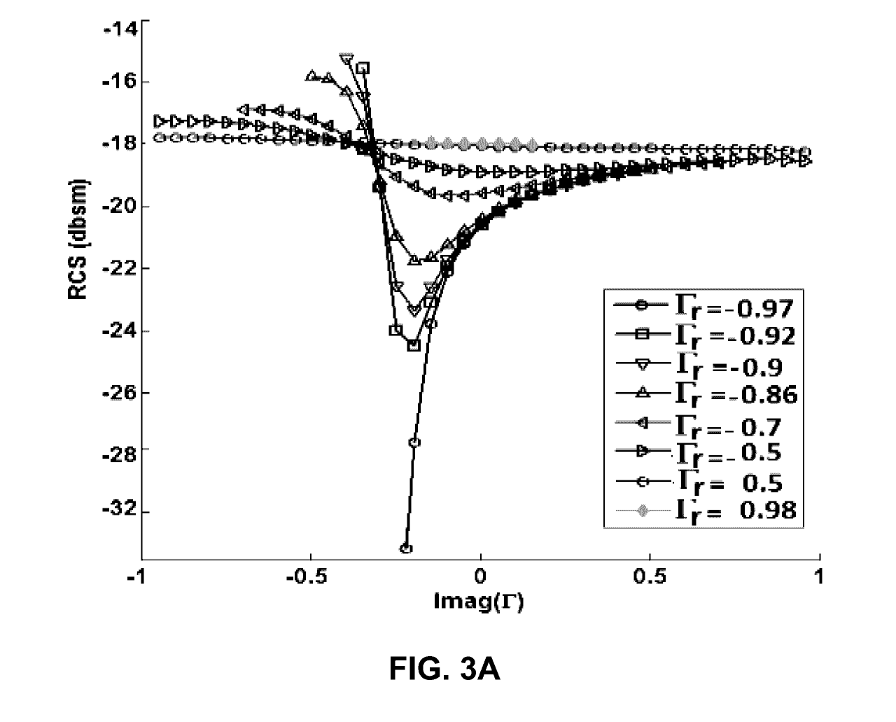

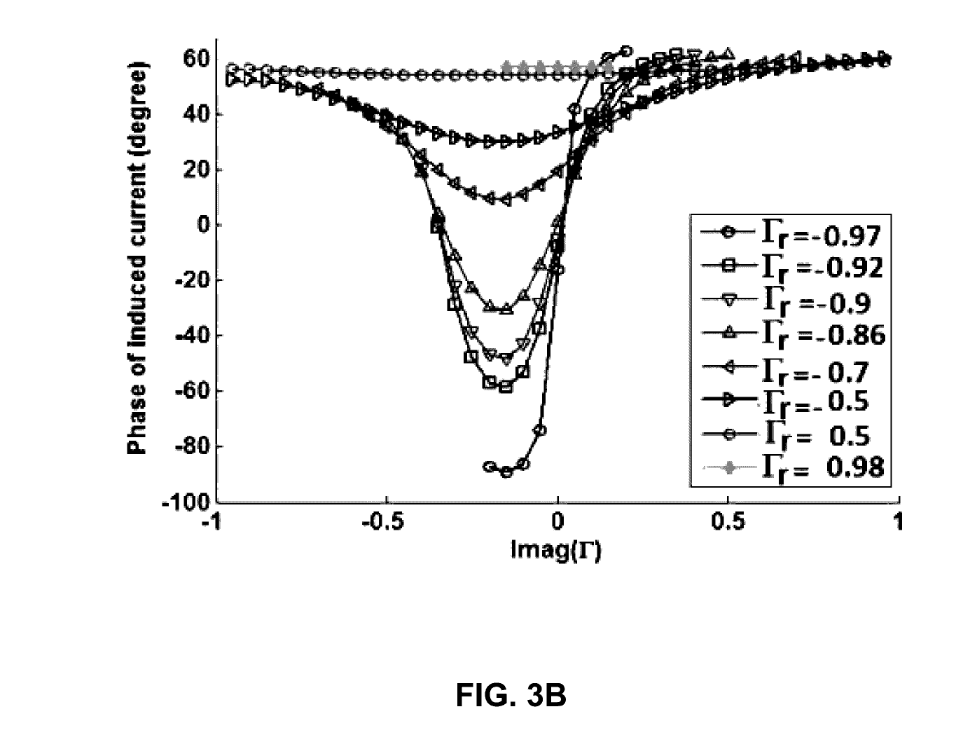

The T-match bowtie antenna from [5] is considered for our study at the same design frequency of f=915 MHz. The antenna input impedance at the design frequency is found as Zₐ=3.86+j149.56 using CST Studio simulations. The impedance at each point on plane is calculated using (2). The RCS and induced phase at the antenna input is simulated over Γ plane. FIGS. 3 (a) and (b) shows the simulated RCS and induced phase at the input port of the antenna for several constant Γᵣ lines as a function of on the antenna Γ plane. On the most left side of Γ plane (Γᵣ=−0.97) the RCS is minimum at <Γᵣ=−0.97, Γᵢ=−0.24>. Next, on the line Γᵣ=−0.92, RCS starts with a maximum (˜−15 dBsm) at <Γᵣ; =−0.92, r; =−0.4), then plunges to ˜−24 dBsm at Γᵣ; −0.92, Γᵣ; −0.24) and then increases to ˜−19 dBsm at Γᵣ; =−0.92, r; =0.4). This behavior repeats for constant lines Γᵣ; =−0.9, −0.86, −0.7. At Γᵣ; =0.5, RCS reaches to a constant value at ˜−18 dBsm for all Γᵢs. Finally, at the most right side of the Γ plane again the RCS is constant on line Γᵣ=0.98. As for the induced phase at the input port of the antenna, at the most left side of the Γ plane on the line Γᵣ=−0.97 the induced phase changes from φ₁˜−90° at (Γᵣ; −0.97, r; =−0.25) to φ₂˜−65° at (Γr=−0.97, I=0.25). By moving toward the right side of Γ plane the induced phase tend to take a constant value over the entire Γᵢs. At the most right side of Γ plane the induced phase on line Γᵣ=0.98 is a constant value at φ˜58°.

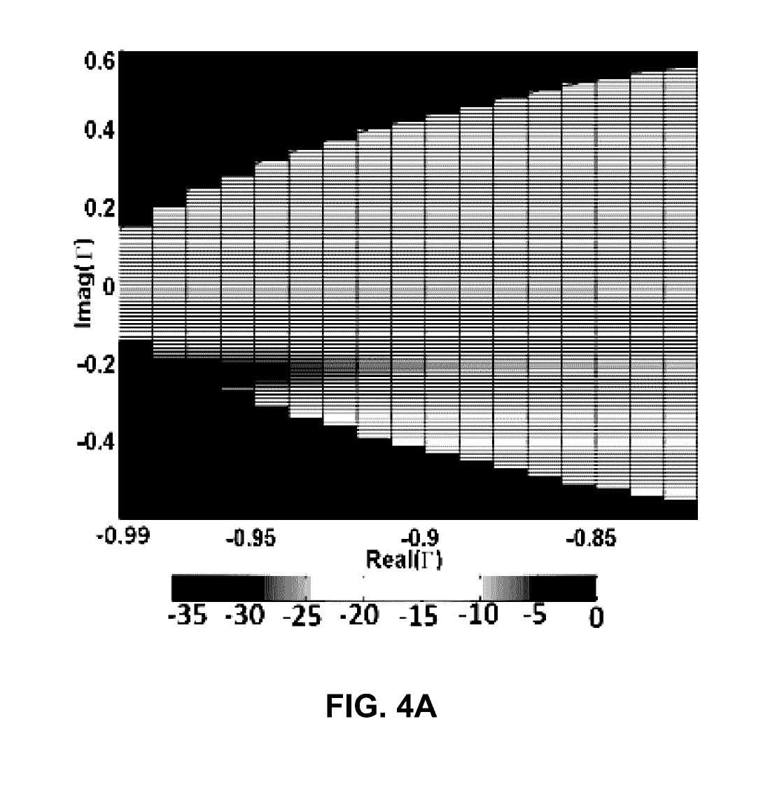

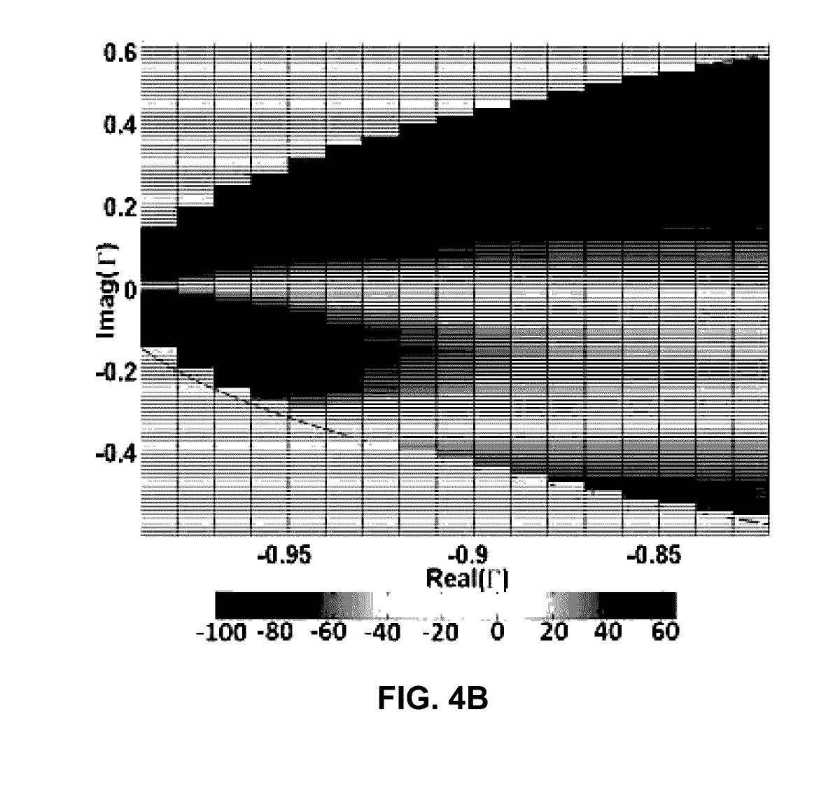

We noticed that the variation of both RCS and induced phase in the left side of the Γ plane of the antenna is considerably higher comparing to the right side of the Γ plane. To understand the behavior of the RCS better simulation is repeated at the left side of the Γ plane of the antenna using a finer step. FIGS. 4 (a) and (b) show the simulated RCS and induced phase at the input port of the antenna in the left side of the Γ plane of the antenna using Δδ=0.01 From FIG. 4 (a), it is understood that at (Γr=−0.97, r, =−0.25) RCS reaches to a minimum around ˜−35 dBsm. However, immediately at the right side of this area there is a maximum scattering area with RCS˜−15 dBsm. The variation of the phase in this area on Γ plane is very steep as shown in FIG. 4 (b). As an example at (Γr=−0.99, I; =−0.15) the induced phase is φ˜−100°. While the induced phase at Γᵣ; =−0.99, r; =+0.15) is φ˜+60°. The RCS at both of these scattering states are approximately RCS˜−22 dBsm. Although the distance of these two scattering states on Γ plane is very small (ΔΓ=0.3) they can provide ˜±160° phase shift at the backscattering from the antenna. This feature can be used to achieve to a wide differential backscattering signal.

According to the results, the T-matched bowtie antenna has two primary and secondary maximum scattering areas. The primary scattering area is predicted by Green model in (1) at the right side of the antenna's Γ plane. The RCS at this area is found around ˜−19 dBsm. On the other hand, the secondary maximum scattering area has not been predicted by Green model. Interestingly, the RCS at this area is approximately ˜−15 dBsm which is higher than the RCS in the primary maximum scattering area. For the T-match bowtie antenna the big difference between resistance and reactance of the antenna (Zₐ) results in rapid variation of both resistance and reactance of Z_{L} over the left side of the Γ plane using (2). Thus, this rapid change of the antenna input impedance results in rapid change of both RCS and phase in this area. However, for a linear half-wave dipole due to the small difference between the value of the resistance and reactance value of antenna input impedance (Zₐ) by using (2) a uniform change of both resistance and reactance of Z_{L} over the entire Γ plane is obtained. Thus, the variation of RCS and phase are also monotonic over the entire Γ plane.

C) Measurement Setup

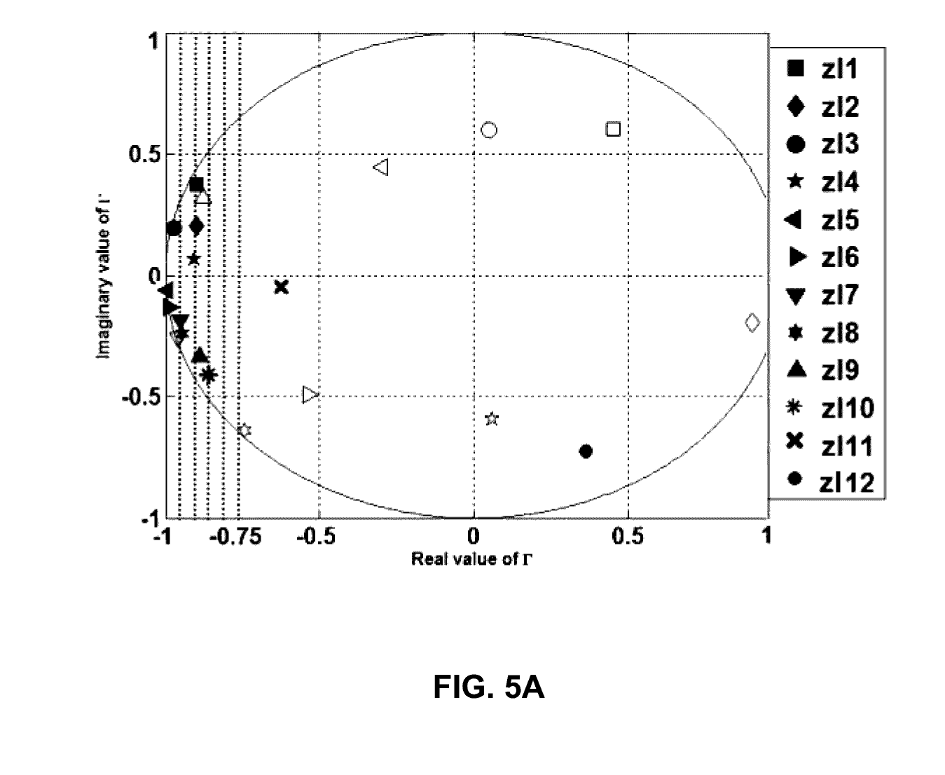

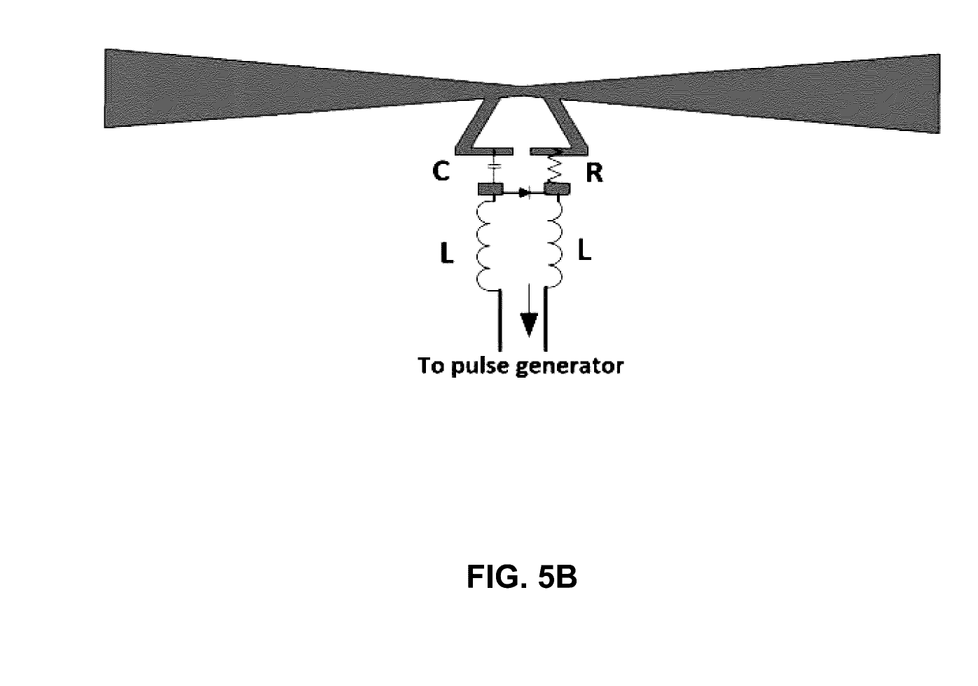

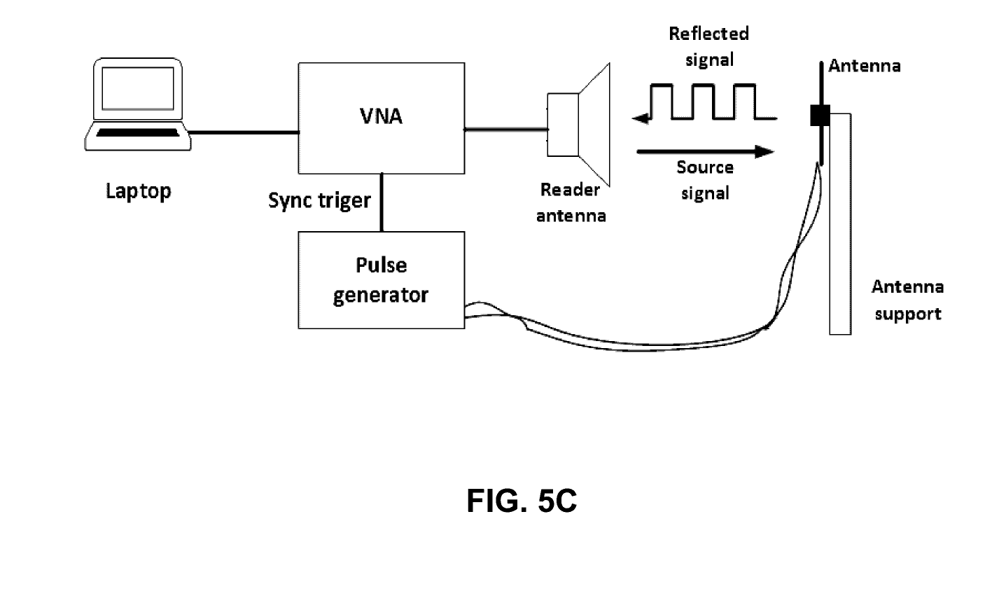

To measure the scattering properties of the two aforementioned antennas, several load impedances were selected over their Γ planes as shown in FIG. 5 (a). Each scattering state in FIG. 5 is represented by a color and a marker type. Yellow and blue colors represent respectively the corresponding loads for half-wave dipole and T-match bowtie antennas. The marker shapes represent the load number for each antenna which are tabulated in Table 1 and 2. These load impedances were selected to place the antenna on a desired area on its plane as shown in FIG. 5 (a). Antennas are prepared by soldering the tabulated impedances in Table 1 and 2 at their input ports as shown in FIG. 5 (b). Modulated scattering technique is used to extract the backscattered signal from the antennas under test from the clutter of environment [6]. A pin diode is soldered at the input port of the antennas as shown in FIG. 5 (b). The diode is biased by connecting the antenna through thin wires to rectangular signal generator Agilent 81150A. The signal generator creates a pulse train at f=10 Hz and ±0.7ν. Wires are made orthogonal to the polarization of the antenna and reader to minimize their interference. A horn antenna is used as the reader antenna and is connected to the VNA Agilent E5061B where S₁₁ is measured. The antennas under test are put individually on the antenna support as shown in FIG. 5 (c). Upon impinging the signal from reader antenna a backscattered field is produced from the antenna under test. By changing the state of the diode it is possible to modulate the induced ac current on the antenna and hence the scattered field. To isolate the induced current on the antennas from the thin bias wires, inductors (L=100) are soldered between the pin diode and wires as shown in FIG. 5 (b). The measured S₁₁ is proportional to the vitiation of backscattered field from the antenna [6]. Since the scattered field also is proportional to the induced current on the antennas (I) we have S₁₁ φ I[6].

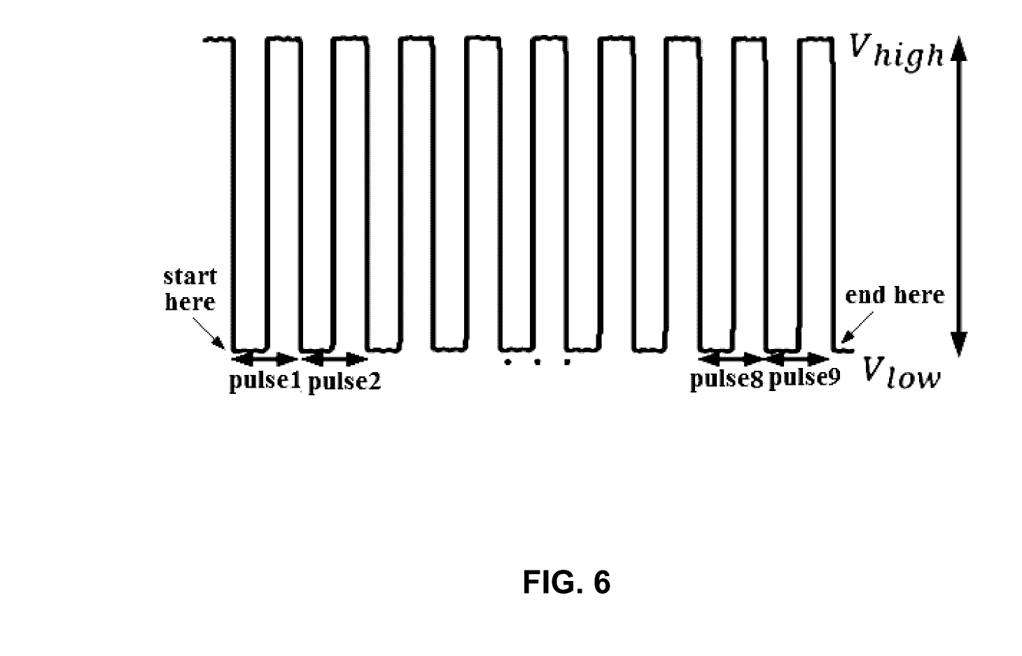

Furthermore, since the RCS of an object is

$$σ = {lim}_{r -> ∞} 4 π {r}^{2 \frac{{\vert {E}_{S} \vert}^{2}}{{\vert {E}_{i} \vert}^{2}}}$$

where Eₛ is the scattered field from the antenna and Eᵢ is the incident wave form reader, the RCS from the antenna and its current are related by √σφ1. FIG. 6 depicts a measured S₁₁ signal. The modulation depth for the backscattered signal is defined as [1], [15]

$$MD = \frac{{V}_{high} - {V}_{low}}{{V}_{high}}$$

and is a measure of how much the modulated variable of the carrier signal varies around its unmodulated level. To demodulate the backscattered field we use:

$${P}_{d} = \frac{1}{{N}_{p}} Σ \frac{N}{n} = 1 {S}_{11 ( n ) Λ ( n )} .$$

where Λ(n) is a sign function which is triggered to +1 and −1 when the diode changes its state. For this setup N=500. The demodulated backscatter signal (P_{d}) has a complex value (P_{d}=|p_{d}|≮p_{d}=δe^{jφ}. Since P_{d} is the integral of the measured S₁₁ we also have P_{d} φI and P_{d} φ\sqrt{σ}.

TABLE 1
Selected loads for half wave dipole antenna

| | | |
|---|---|---|
| Z_{L1} =20Ω + 0.7 pF | Z_{L4} = 50Ω + 2 pF | Z_{L7} = 17.8Ω + 110 nH |
| Z_{L2} = 4.5Ω + 1 pF | Z_{L5} = 118Ω + 0.5 pF | Z_{L9} = 10Ω + 22 nH |
| Z_{L3} = 50Ω + 0.6 pF | Z_{L6} = 118Ω + 12 nH | Z_{L9} = 118Ω + 0.2 pF |

TABLE 2
Selected loads for T-match bowtie antenna

| | | |
|---|---|---|
| Z_{L1} = 0.2Ω + pF | Z_{L5} = 10Ω + 5 pF | Z_{L9} = 2.26Ω + 1.3 pF |
| Z_{L2} = 10Ω + 0.94 pF | Z_{L6} = 0.5Ω + 1.8 pF | Z_{L10} = 0.5Ω + 1.26 pF |
| Z_{L3} = 0.9 pF | Z_{L7} = 5.1Ω + 1.5 pF | Z_{L11} = 15Ω + 1.15 pF |
| Z_{L4} = 50Ω + 0.9 pF | Z_{L8} = 2.26Ω + 1.4 pF | Z_{L12} = 0.5Ω + 1.15 pF |

To compare the phase of scattered field the same references must be kept: (1) All backscattering signals (P_{d}) are measured with reference to the open circuit state (reverse bias of diode) at the antennas. (2) The antennas must be placed exactly at the same place on the antenna support shown in FIG. 5 (b). (3) All received signals must be integrated with the same Λ(n). For the latter case, in each measurement the starting point of a complete pulse in the received backscattered signal is found as shown in FIG. 6. Afterward, the same Λ(n) function is used to integrate 9 following pulses from the backscattered signal.

D) Measurement Results

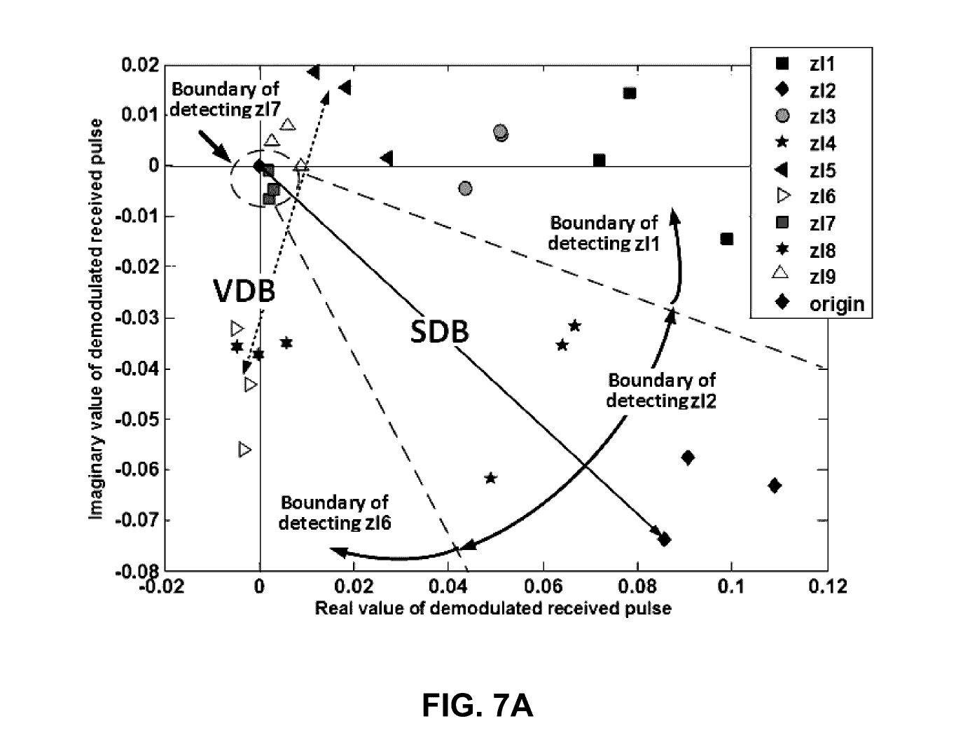

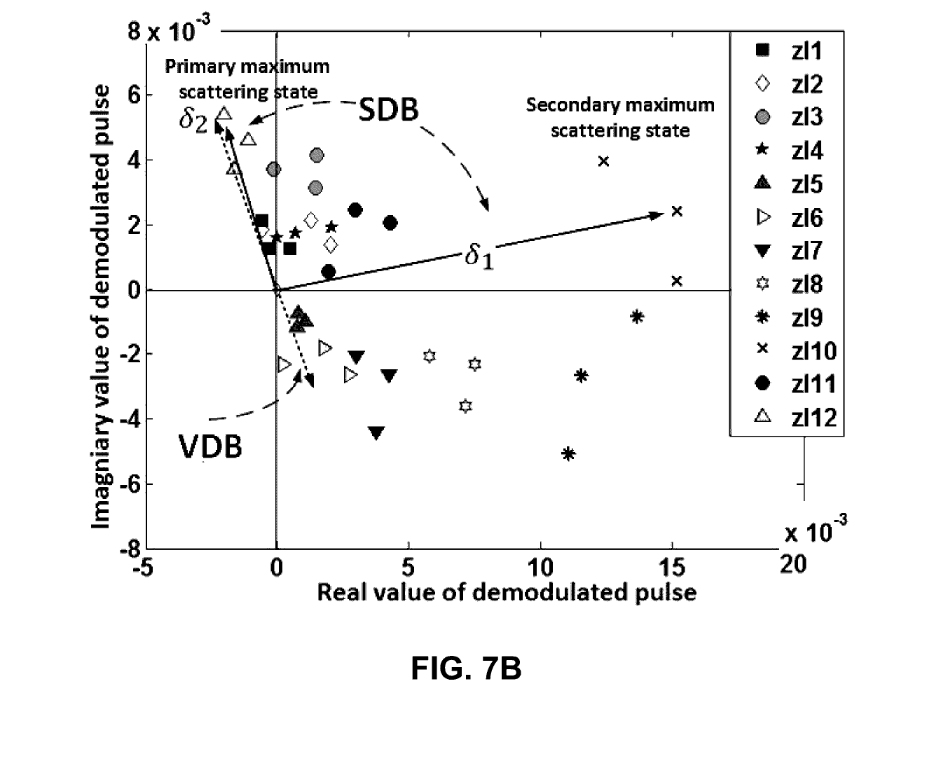

Measurement is conducted for each prepared antenna for three times. FIGS. 7 (a) and (b) show the real and imaginary values of the demodulated signal (P_{d}) for different scattering states of half-wave dipole and T-match bowtie antennas respectively. Generally, three measurements for the same scattering states are in agreement with each other. The error in measurements can be generated by not placing the antenna on the same exact place as before and also by any movements of the antenna support itself. According to FIG. 5 (a), Z_{L7} and Z_{L2} for half-wave dipole are in the minimum and maximum scattering areas respectively. Measurement results show that at these loads P_{d} reaches to its minimum and maximum values respectively. Also, comparing to Z_{L2} at scattering states Z_{L1}, Z_{L3}, Z_{L5} and Z_{L9} the magnitude of P_{d} decreases while leading in phase with that of Z_{L2}. This observation is in agreement with FIG. 2 (b) where loads Z_{L1}, Z_{L3}, Z_{L5}, Z_{L9} lead the induced phase of Z_{L2} by ΔΦ˜40°, ΔΦ˜50°, ΔΦ˜60°, ΔΦ˜85° respectively. These loads are all in the top side of Γ plane of half-wave dipole. For loads Z_{L4}, Z_{L6}, Z_{L8} which are located in the bottom side of Γ plane the magnitude of Pa comparing to Z_{L2} decreases while lagging in phase with that of Z_{L2} as noticed from measurement results in FIG. 7 (a). This lag in phase is ΔΦ˜15°, ΔΦ˜60°, ΔΦ˜70° respectively for loads Z_{L4}, Z_{L6}, Z_{L8}. The simulations and measurement results for studying RCS of the linear half-wave dipole is in agreement with (1).

For T-match bowtie antenna, the backscattering characteristics at loads Z_{L1} to Z_{L4} which are on the upper (Γᵢ>0) left side of Γ plane of the T-match antenna have approximately the same magnitude and phase. By moving to Γᵢ<0 on the left side of Γ plane, i.e. scattering states Z_{L5}, Z_{L6} and Z_{L7}, a big change in the induced phase is noticed as understood from the phase of the measured P_{d}. This is in agreement with simulation results in FIG. 4 (b). Simulation results showed a secondary maximum scattering area at scattering states Z_{L7}, Z_{L8}, Z_{L9} and Z_{L10}. As understood from measurement results, by moving toward the secondary maximum scattering area (Z_{L7} to Z_{L10}) an increase in the magnitude of P_{d} is noticed. At the same time, the induced phases at the input port of the antenna grow more positive when moving from Z_{L6} to Z_{L10} in FIG. 4 (b). This behavior is observed in FIG. 7 (b) where P_{d} for Z_{L6} to Z_{L10} are leading in phase comparing to the phase of Z_{L5} (ΦZ_{L5}< . . . <ΦZ_{L10}). For Z_{L12} which is close to the primary maximum scattering area of the antenna the variation of the phase is close to that of Z_{L1} to Z_{L4} as expected from simulations results.

According to the results, a T-match bowtie antenna has two maximum scattering areas on its Γ plane: the primary area which is predicted by Green model and the secondary area which is not described by Green model. Furthermore, as understood from results the RCS of T-match antenna at its secondary maximum scattering state is higher than antenna RCS in primary maximum scattering state. This behavior is not predicted by (1). The steep variation of RCS of T-match bowtie antenna in a small area has both advantages and disadvantages. By changing a small value in the load of the antenna large variation of RCS is achieved which is an advantage. On the other hand, the disadvantage of this feature can be attributed to the shift of impedance due to temperature and also the sensitivity of the loads resulting in an un-wanted change in the impedance and as a result the corresponding RCS of the antenna.

According to the measurement results, for both antennas two scattering states with differential phase Δφ˜180° can be achieved. These scattering states are {Z_{L5}, Z_{L6}} and {Z_{L6}, Z_{L12}} for half-wave dipole and T-match bowtie antennas respectively. However, the resultant vector differential backscattering (VDB) for both antennas are not higher than that those of scalar differential backscattering (SDB) obtained by Green model. Thus, using VDB is not beneficial over SDB. However, it is possible to generate higher order modulation by defining the boundaries of detection. As an example, four scattering states for the half-wave dipole can be considered as {Z_{L1}, Z_{L6}, Z_{L2}, Z_{L7}}. Consequently, they can provide 2 bits to encode {00, 01, 10, 11} in a stream of data. The boundaries of detection for these states are characterized in FIG. 7 (a).

### III. THE PROPOSED ANTENNA DESIGN

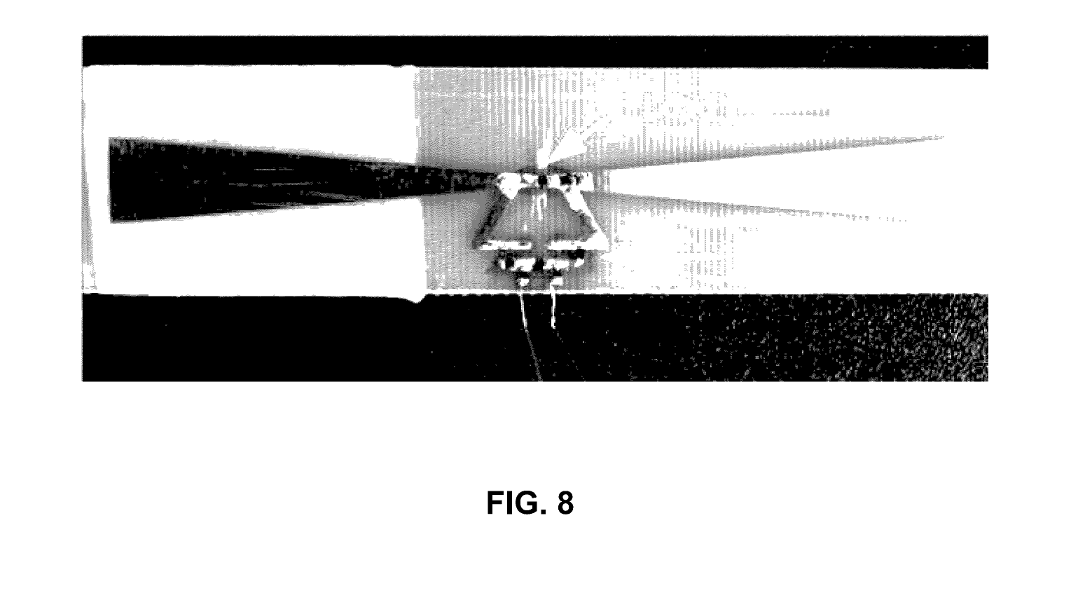

In this Section, we explain our proposed dual loading design for the studied T-match bowtie antenna and we present our measurement results. We show that by selecting appropriate loads the antenna can be places at different scattering states with various magnitudes over 360° phases span in I-Q plane. A 1 mm gap is created in the center of the antenna as shown in FIG. 8. The first stimulus on the antenna, i.e. Load 1, is soldered to the antenna at this place as shown in FIG. 8. Next, the second stimulus of the antenna, i.e. Load 2, is soldered at the input port of the antenna as shown in FIG. 8. In this paper, only inductive loads and an open circuit (O.C) case for Load 1 are studied. All studied Load 1's are listed in Table 3. All studied Load 2's in this paper are also tabulated in Table 4. Next, the measurement results for using one fixed load and using several loads at Load 1 are presented respectively in next two subsections.

TABLE 3
Studied loads for Load 1.
Load 1

| | | | | | | |
|---|---|---|---|---|---|---|
| 2.2 nH | 3.3 nH | 5.1 nH | 10 nH | 12 nH | 22 nH | Open circuit |
| | | | | | | (O.C) |

TABLE 4
Selected loads for Load 1

| | | |
|---|---|---|
| Z_{L1} = 20Ω, 0.5 pF | Z_{L6} = 1.47Ω, 0.6 pF | Z_{L11} = 34.8Ω, 0.2 pF |
| Z_{L2} = 30Ω, 44 nH | Z_{L7} = 50Ω, 0.05 pF | Z_{L12} = 357Ω, 0.6 pF |
| Z_{L3} = 10Ω, 5 pF | Z_{L8} = 0.1Ω, 770 nH | Z_{L13} = 71.5Ω, 1.2 pF |
| Z_{L4} = 15Ω, 4 pF | Z_{L9} = 180Ω, 0.1 pF | Z_{L14} = 34.8Ω, 10 nH |
| Z_{L5} = 20Ω, 1 pF | Z_{L10} = 50Ω, 100 nH | Z_{L15} = 34.8Ω, 0.3 pF |

A. Using One Load 1

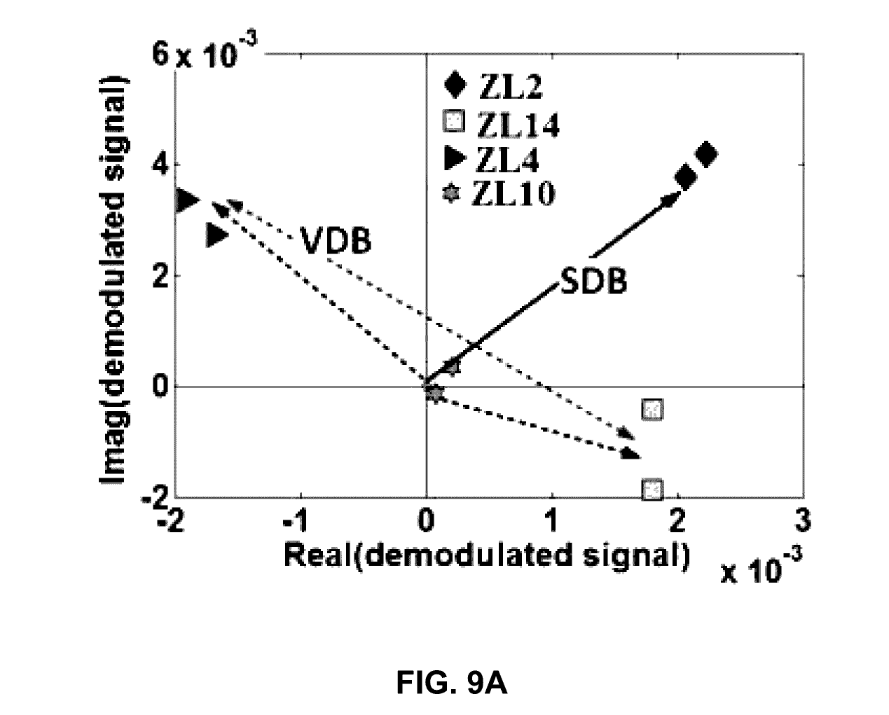

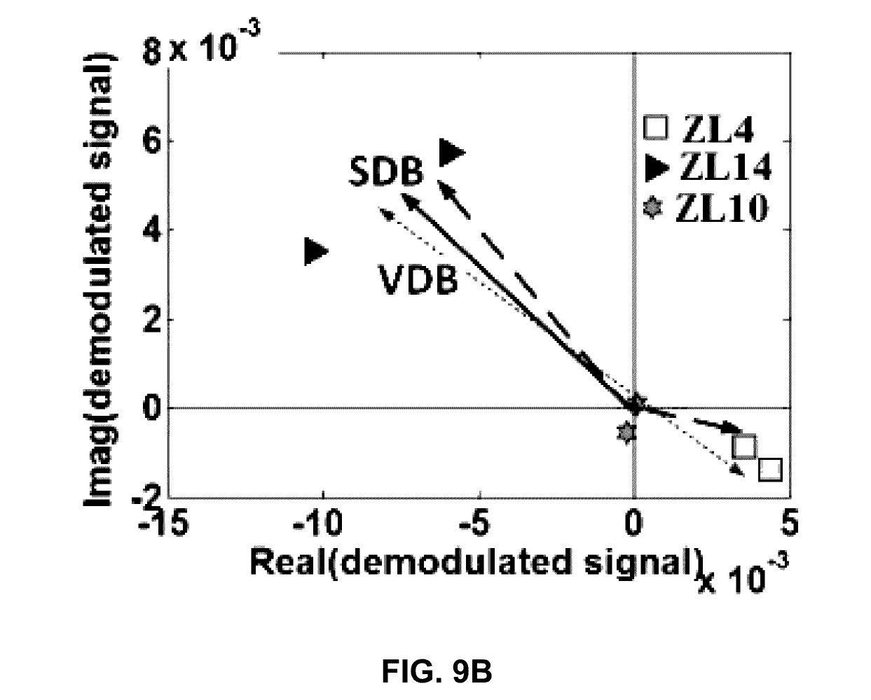

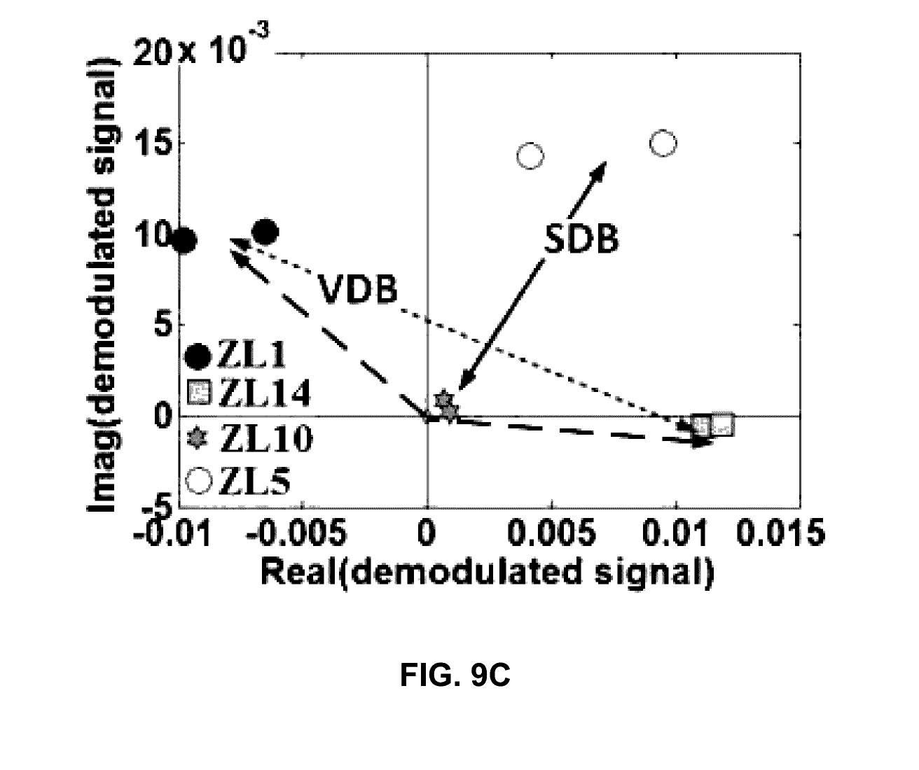

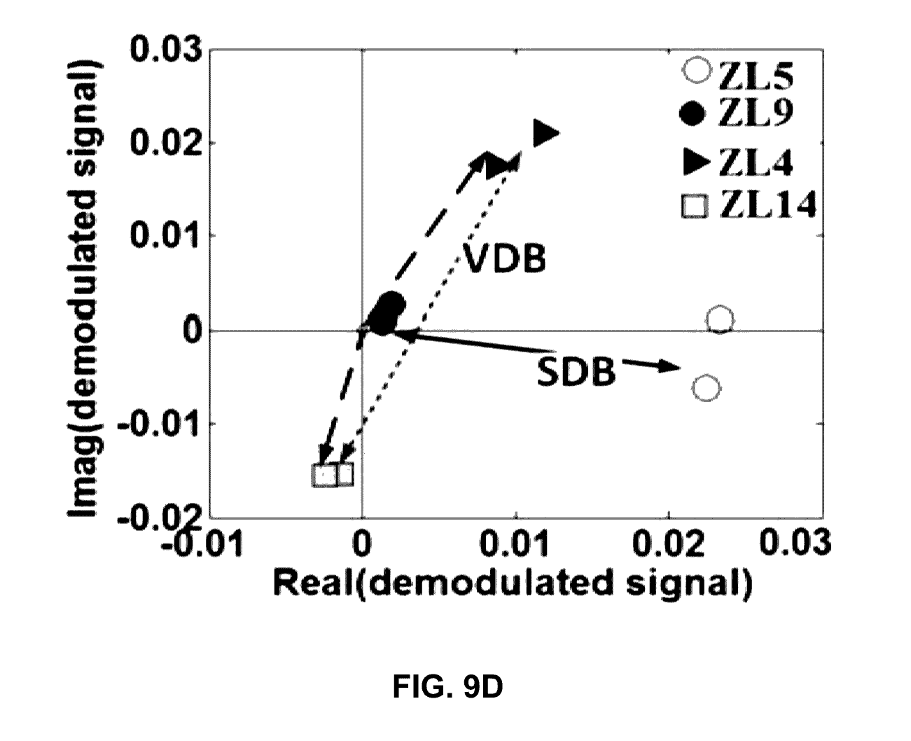

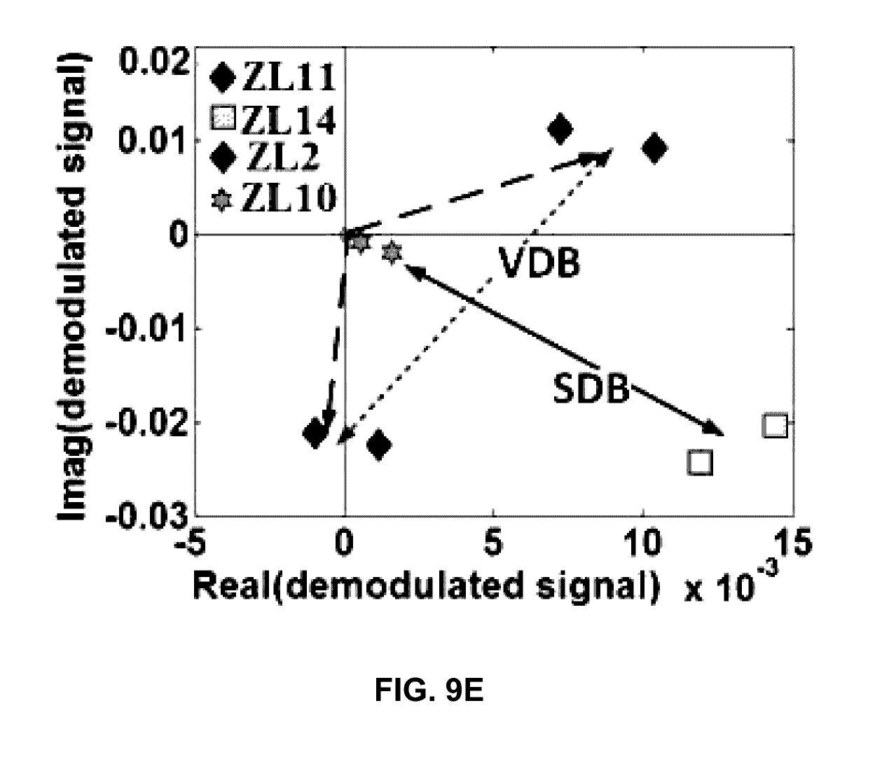

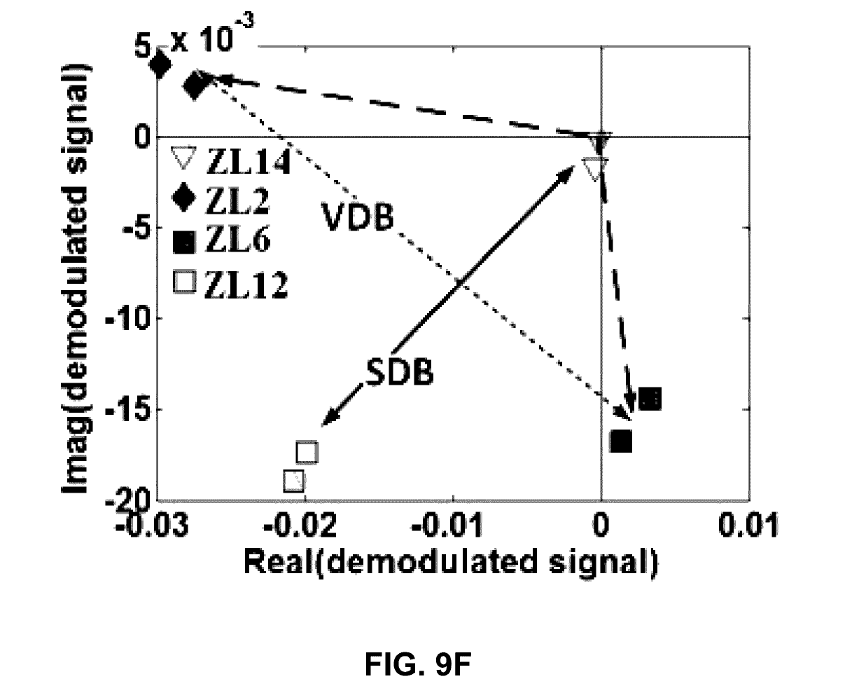

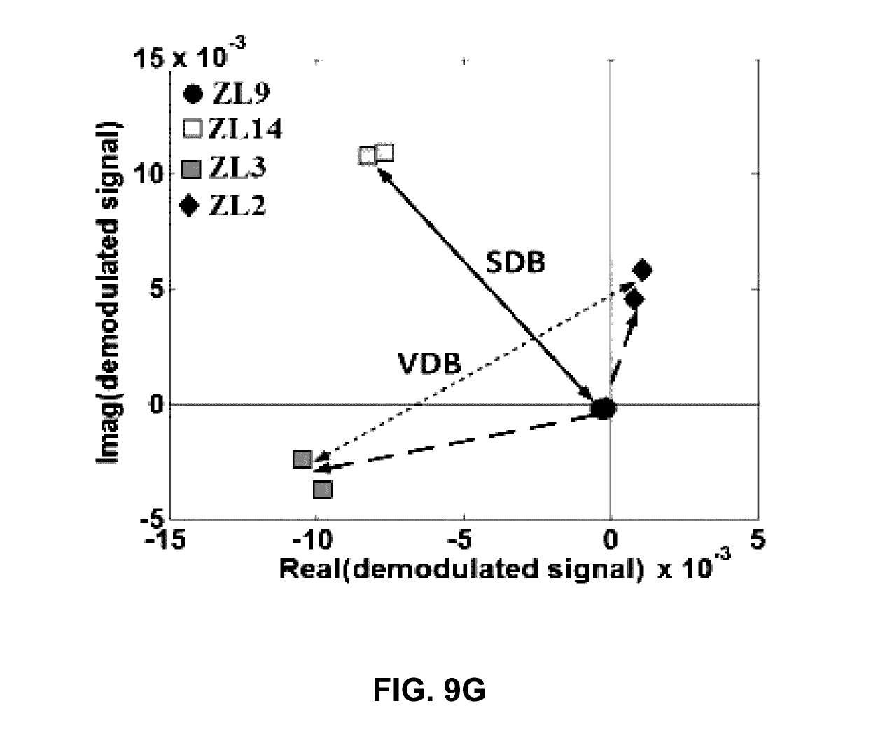

A measurement set is considered by using a fixed Load 1 and all Load 2's in Table 4. Measurements are performed for all 15 combinations for 2 times. The highest SDB and VDB for the measurement set are recorded. For SDB, two minimum and maximum scattering states of the antenna by Green model are considered. For VDB, two high scattering states of the antenna which can provide the biggest differential phase are considered. Next, the measurement is repeated for all other sets which consist of other Load 1 and all 15 Load 2's. FIG. 9 shows the real and imaginary values of the demodulated signal (Pa) for the highest achieved SDB and VDB in all measurement sets. These results are all tabulated in Table 5.

TABLE 5
Results from measurement for SDB
and VDB for new antenna design

| | Load | | | SDB | Load | | | VDB |
|---|---|---|---|---|---|---|---|---|
| | 2/SDB | | Max\|δ\| | MD | 2/VDB | | \|Δδ\| | MD |
| Load 1 | Max | Min | X10⁻³ | (%) | s₁ | s₂ | X10⁻³ | (%) |
| 22 nH | Z_{L14} | Z_{L12} | 30.0 | 99.2 | Z_{L2} | Z_{L6} | 35.1 | 124.5 |
| 12 nH | Z_{L14} | Z_{L10} | 25.4 | 95.8 | Z_{L2} | Z_{L11} | 33.7 | 158.2 |
| 10 nH | Z_{L5} | Z_{L9} | 24.3 | 95.7 | Z_{L4} | Z_{L14} | 31.2 | 162.6 |
| 5.1 nH | Z_{L5} | Z_{L10} | 17.9 | 94.0 | Z_{L1} | Z_{L14} | 23.7 | 173.7 |
| 3.3 nH | Z_{L14} | Z_{L10} | 5.9 | 99.7 | Z_{L4} | Z_{L14} | 8.3 | 142.0 |
| 2.2 nH | Z_{L2} | Z_{L10} | 4.3 | 96.4 | Z_{L4} | Z_{L14} | 6.2 | 176.2 |
| O.C. | Z_{L14} | Z_{L9} | 13.5 | 99.5 | Z_{L2} | Z_{L3} | 14.5 | 138.4 |

At different measurement set different loads provide the highest VDB and SDB. In some cases, using VDB has no superiority over SDB in increasing the differential backscattered signal (e.g. Load 1=10 nH, 12 nH, OC). However, for other sets with other Load 1's (Load 1=2.2 nH, 5.1 nH, 22 nH) the improvement in differential backscattered signal in VDB over SDB is substantial. The modulation depth for VDB and SDB for all cases in FIG. 9 were calculated and are tabulated in Table 5. For SDB, the modulation depth is limited to 100% (93%<MD<99.68%). However, for VDB the modulation depth takes higher values than 100% (124.56<MD<176.16). The reason for this is that in VDB the two scattering states are not in the same quadrature of I-Q plane and the vector distance between two scattering states increases. Consequently, MD in (3) increases. Another interesting observation in the results is that by increasing the inductance value in Load 1 from 2.2 nH to 22 nH the magnitude of the maximum scattering states (max{|p_{d}|}) increases substantially. As an example, magnitude of P_{d} in Load 1=2.2 nH/Load 2=Z_{L2} and Load 1=22 nH/Load 2=Z_{L2} are in these two scattering states are 4.3×10⁻³ and 30×10⁻³ respectively. The simulated RCS of the antenna in these two states are 54 Cm² and 294 Cm² respectively.

B. Using Several Load 1's

In this section, the high scattering states from different sets are compared with each other. The realization of this scenario can be achieved by load switching at Load 1. The demodulated backscattering signal of all operation modes can be compared with each other when the same Λ(n) is used for demodulating the received signals for all cases. Thus, scattering states from different sets can be compared with each other. There are two reasons for this. The first reason is to find high scattering states with 180 phase shift. Thus, a pure BPSK modulation with 200% modulation depth can be realized. The second reason is to realize higher order modulation to encode more bits.

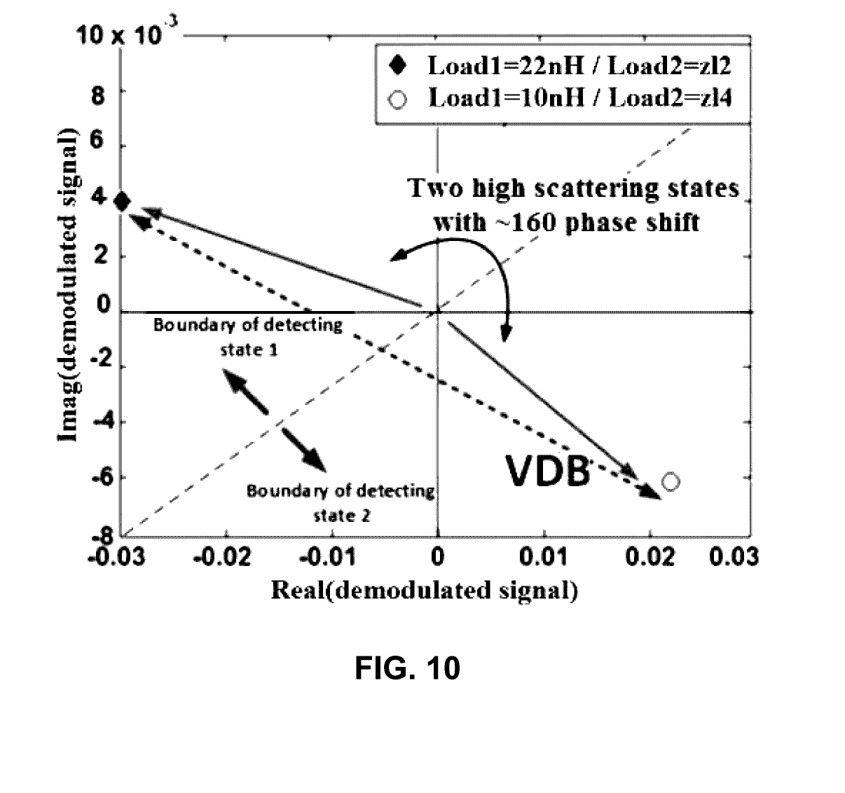

FIG. 10 shows two high scattering states of the antenna from two different sets: {Load1=22 nH/Load2=Z_{L2}} and {Load1=10 nH/Load2=Z_{L4}}. The differential phase for these two scattering states is approximately ˜Δφ=160° as shown in FIG. 10. Although the two scattering states are not exactly symmetric (MD=166.17%) the magnitude of the vector differential backscattering signal increases to |Δδ=49.8×10⁻³|. Whereas the magnitude of the vector differential backscattered signal at each individual case is bounded to 6.2×10^{<}|Δδ<35.1×10⁻³|. Using higher VDB signals backscattering links are more immune to the noise and interference in the environment. Furthermore, the coverage range in backscattering links can be increased without increasing the power at the reader antenna. These scattering states can encode one bit or two states. Boundaries of detection for each scattering state in FIG. 10 are shown by a dashed line. If the demodulated signal falls above this line “state 1” is detected. On the other hand, if the demodulated signal falls below the boundary line “state 2” is detected.

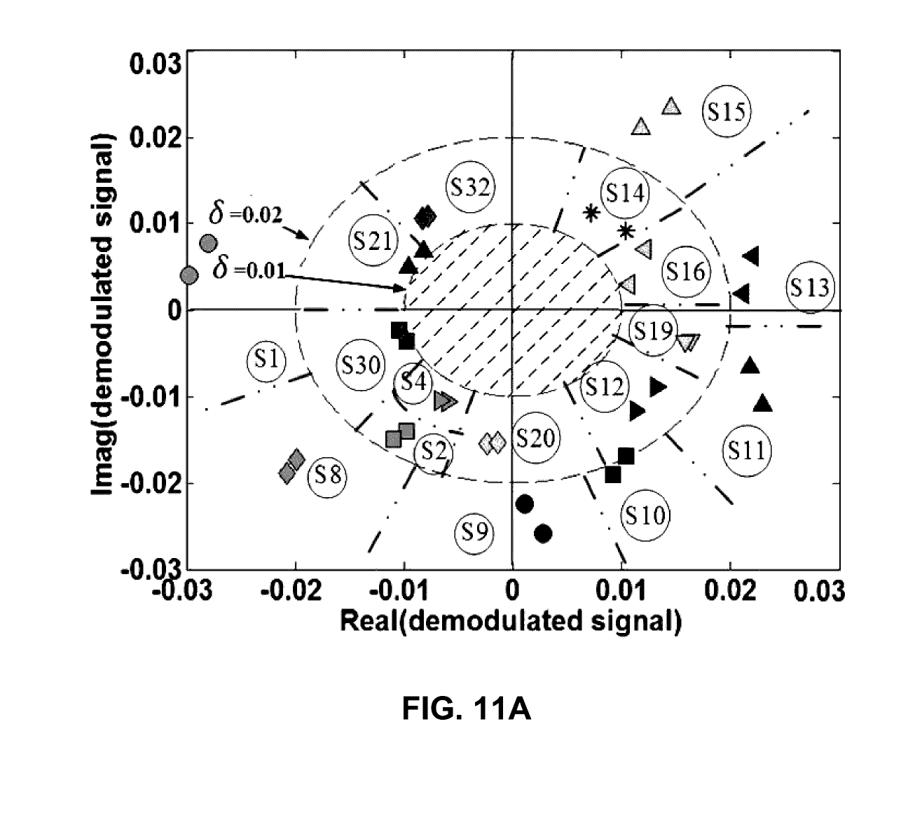

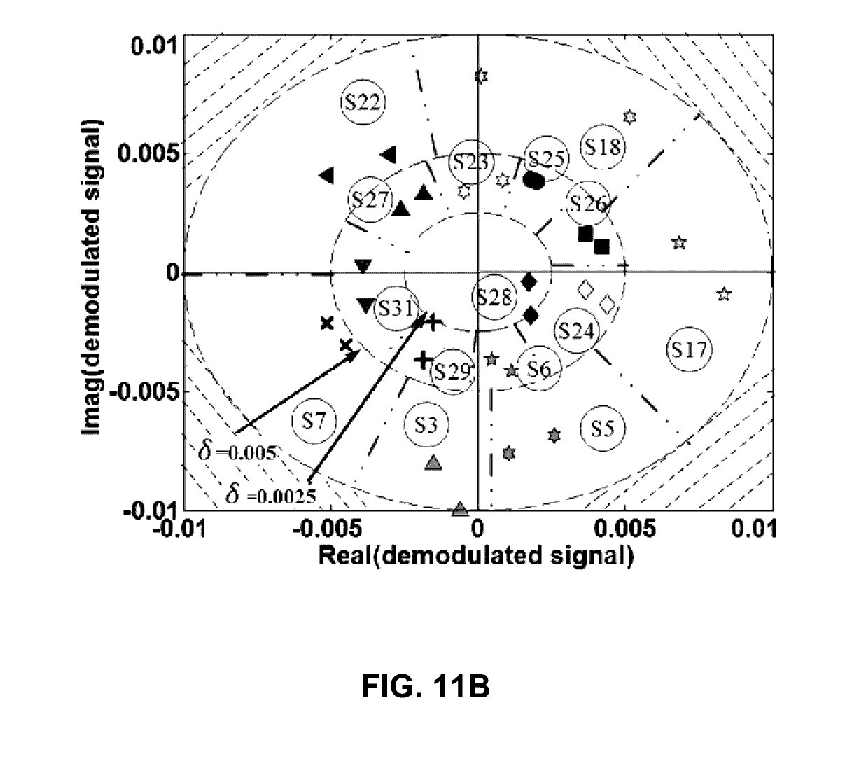

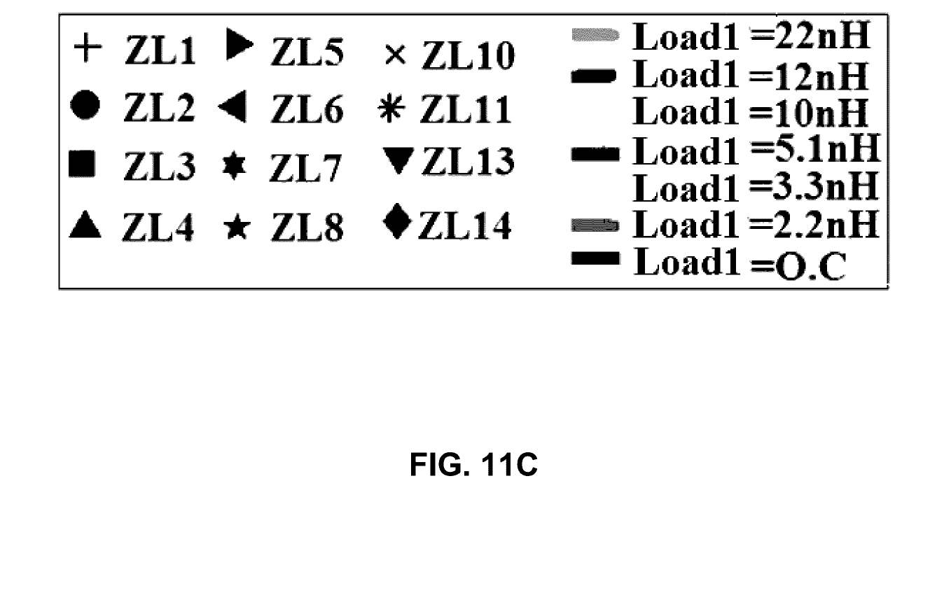

VDB can also be used to increase the modulation order in backscattered links by employing different scattering states with various magnitude (δ=|p_{d}|) and phase (φ=≮p_{d}). FIG. 11 shows 32 scattering states for the proposed antenna design. The measurement for each scattering state is repeated for 2 times. Each scattering state in FIG. 11 is shown by a marker color and a type. The color of the scattering state shows its Load 1. The type of the scattering state shows its Load 2. The boundaries of detection for each scattering state are characterized by red dashed lines. All of these scattering states are tabulated in Table 6. The scattering states can be categorized based on the magnitude of the demodulated signal (δ). Four boundaries for the magnitudes are considered: (1) δ>0.02, (2) 0.01<δ<0.02, (3) 0.005<δ<0.01, (4) δ<0.005. FIG. 11 (a) shows the scattering states with 0.01>δ and FIG. 11 (b) shows the scattering states with 0.01<δ. Scattering states {s₁, s₈, s₉, s₁₀, s₁₁, s₁₃, s₁₅} are high scattering states which are located at δ>0.02. These 7 scattering states are located in approximately Δφ˜260° phases span.

TABLE 6
32 scattering states for the proposed quasi-32-QAM

| Load 1 | Z_{L1} | Z_{L2} | Z_{L3} | Z_{L4} | Z_{L5} | Z_{L6} | Z_{L7} | Z_{L8} | Z_{L10} | Z_{L11} | Z_{L13} | Z_{L14} |
|---|---|---|---|---|---|---|---|---|---|---|---|---|
| marker | + | | ▪ | ▴ | [symbol] | [symbol] | [symbol] | ★ | [symbol] | * | ▾ | ♦ |
| 22 nH | — | S₁ | S₂ | S₃ | S₄ | — | S₅ | S₆ | S₇ | — | — | S₈ |
| 12 nH | — | S₉ | S₁₀ | S₁₁ | S₁₂ | S₁₃ | — | — | — | S₁₄ | — | — |
| 10 nH | — | — | — | S₁₅ | — | S₁₆ | S₁₇ | S₁₈ | — | — | S₁₉ | S₂₀ |
| 5.1 nH | — | — | — | S₂₁ | — | S₂₂ | — | — | — | — | — | — |
| 3.3 nH | — | — | — | — | — | — | S₂₃ | — | — | — | — | S₂₄ |
| 2.2 nH | — | S₂₅ | S₂₆ | S₂₇ | — | — | — | — | — | — | — | S₂₈ |
| O.C. | S₂₉ | — | S₃₀ | — | — | — | — | — | — | — | S₃₁ | S₃₂ |

Scattering states {s₂₁, s₃₂, s₁₄, s₁₆, s₁₉, s₁₂, s₂₀, s₂, s₄, s₃₀} are located in 0.01<δ<0.02. These 10 scattering states are located in a Δφ˜360° phase span. Scattering states {s₇, s₃, s₅, s₁₇, s₁₈, s₂₂} are located in 0.005<δ<0.01. These 6 scattering states are located in a Δφ˜360° phase span. Scattering states {s₃₁, s₂₉, S₆, s₂₄, s₂₆, s₂₄, s₂₃, s₂₇} are located in 0.0025<δ<0.005. These 8 scattering states are located in a Δφ˜360° phase span. And lastly, scattering state s₂₈ are at the δ˜0.0025 and −45°<φ<0° phase span.

The characterized scattering states, however, are not orthogonal. Thus, they can provide a quasi-32-QAM. This quasi-32-QAM can encode 5 bits in a backscattered link. If the noise and interference from the environment is high the scattering states are drifted from their boundaries to other boundaries and error in detection in RFID reader can be generated. Thus, in this case lower bit rate (e.g. quasi-16-QAM) must be used to avoid errors.

### IV. CONCLUSION

In this paper, first we presented a study on RCS and variation of phase of current for a linear half wave dipole and a resonant T-match bowtie antenna over their Γ planes. The simulation and measurement results show that the behavior of a linear antenna can be well predicted by the well-known Green model in (1). However, we showed both by measurements and simulations that against the widespread assumption in the literature the RCS of a T-match bowtie antenna cannot be modeled by Green model. We showed that a T-match bowtie antenna has two maximum scattering areas on its plane. Next, we introduced a new design for RFID antennas by using dual loading. We showed by measurements that the proposed deign can produce various scattering states with different magnitudes within 360 phase span. This property of the proposed antenna can be used to: (1) improve the backscattering signal strength and modulation depth and consequently the coverage range in passive backscattering links, (2) increase the order of modulation to encode more bits in backscattering links. Specifically, the new antenna design can provide a quasi-32-QAM modulation for its backscattering link.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system 105 components in the embodiments described above should not be understood as requiring such separation in all embodiments, and it should be understood that the described program components and systems may typically be integrated together in a single hardware and/or software product or packaged into multiple hardware and/or software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A T-match bowtie antenna system, comprising:
a t-match antenna having a first side and a second side, wherein the antenna is dual loaded;
a first load soldered to the first side of the antenna;
a second load soldered to the second side of the antenna; and
a gap defined by the space between the first load and the second load, wherein the gap is approximately one millimeter in length;
wherein the antenna is capable of providing quasi-32-QAM encoding.
